(19) United States
(12) Patent Application Publication
(10) Pub. No.: US 2021/0284494 A1
(43) Pub. Date: Sep. 16, 2021

(54) ELEVATOR SYSTEM CROWD DETECTION BY ROBOT

(71) Applicant: Otis Elevator Company, Farmington, CT (US)

(72) Inventors: Yu Zhang, Shanghai (CN); Shenhong Wang, Shanghai (CN); Stephen Richard Nichols, Plantsville, CT (US); Michael P. Keenan, JR., Suffield, CT (US)

(21) Appl. No.: 17/100,509

(22) Filed: Nov. 20, 2020

(30) Foreign Application Priority Data
Mar. 16, 2020 (CN) 202010181799.4

(51) Int. Cl. B66B 5/00; B66B 1/34; B66B 1/46

(52) U.S. Cl. CPC B66B 5/0012; B66B 1/3461; B66B 1/3476; B66B 2201/215; B66B 2201/4638; B66B 2201/4653; B66B 1/468

(57) ABSTRACT

A method of operating a first elevator system including a first elevator car including detecting an individual using a sensor system of a first robot; and notifying a dispatcher of the first elevator system that the individual was detected.

### CROSS-REFERENCE TO RELATED APPLICATIONS

This application claims the benefit of Chinese Application No. 202010181799.4 filed Mar. 16, 2020, the disclosure of which is incorporated herein by reference in its entirety.

### BACKGROUND

The subject matter disclosed herein relates generally to the field of conveyance systems, and specifically to a method and apparatus for coordinating conveyance system interactions with robots.

Conveyance systems such as, for example, elevator systems, escalator systems, and moving walkways are typically only configured to carry human beings alone.

### BRIEF SUMMARY

According to an embodiment, a method of operating a first elevator system including a first elevator car is provided. The method including detecting an individual using a sensor system of a first robot; and notifying a dispatcher of the first elevator system that the individual was detected.

In addition to one or more of the features described herein, or as an alternative, further embodiments may include detecting the individual approaching the first elevator system using the sensor system of the first robot; determining that the individual would like to utilize the first elevator system; and transmitting an elevator call to the first elevator system.

In addition to one or more of the features described herein, or as an alternative, further embodiments may include detecting the individual entering the first elevator car using the sensor system of the first robot; and notifying the dispatcher of the first elevator system that the individual has entered the first elevator car.

In addition to one or more of the features described herein, or as an alternative, further embodiments may include determining that the individual did not request the first elevator car through an elevator call.

In addition to one or more of the features described herein, or as an alternative, further embodiments may include determining that the individual did request the first elevator car through an elevator call.

In addition to one or more of the features described herein, or as an alternative, further embodiments may include: detecting the individual exiting the first elevator car using the sensor system of the first robot; and notifying the dispatcher of the first elevator system that the individual has exited the elevator car.

In addition to one or more of the features described herein, or as an alternative, further embodiments may include: detecting the individual within the first elevator car using the sensor system of the first robot; and notifying the dispatcher of the first elevator system that the individual is within the elevator car.

In addition to one or more of the features described herein, or as an alternative, further embodiments may include: detecting a number of individuals within the first elevator car using the sensor system of the first robot; and notifying the dispatcher of the first elevator system of the number of individuals within the elevator car.

In addition to one or more of the features described herein, or as an alternative, further embodiments may include: detecting a fullness percentage of the first elevator car using the sensor system of the first robot; and notifying the dispatcher of the fullness percentage.

In addition to one or more of the features described herein, or as an alternative, further embodiments may include: receiving an elevator call from the individual via an elevator call device of the first robot; and transmitting the elevator call from the robot to a dispatcher of the first elevator system.

In addition to one or more of the features described herein, or as an alternative, further embodiments may include: determining that the first elevator car can accommodate the first elevator call; and instructing the first elevator car to move to a landing where the individual is located.

In addition to one or more of the features described herein, or as an alternative, further embodiments may include: determining when the individual has entered the first elevator car using the sensor system of the first robot; and instructing the first robot to enter the first elevator car after the individual has entered the first elevator car.

In addition to one or more of the features described herein, or as an alternative, further embodiments may include: determining when the individual has entered the first elevator car using the sensor system of the first robot; determining that no other individuals are entering the first elevator car using the sensor system of the first robot; and instructing the first robot to enter the first elevator car after the individual has entered the first elevator car and it has been determined that no other individuals are entering the first elevator car.

In addition to one or more of the features described herein, or as an alternative, further embodiments may include: moving the first elevator car to a destination of the elevator call when the individual has entered the first elevator car.

In addition to one or more of the features described herein, or as an alternative, further embodiments may include: determining when the individual has exited the first elevator car at the landing using the sensor system of the first robot; and instructing the first robot to exit the first elevator car after the individual has exited the first elevator car.

In addition to one or more of the features described herein, or as an alternative, further embodiments may include: determining when the individual has exited the first elevator car at the landing using the sensor system of the first robot; determining that no other individuals are exiting the first elevator car using the sensor system of the first robot; and instructing the first robot to exit the first elevator car after the individual has exited the first elevator car and it has been determined that no other individuals are exiting the first elevator car.

In addition to one or more of the features described herein, or as an alternative, further embodiments may include: detecting a number of individuals within an elevator lobby of the first elevator system using the sensor system of the first robot; and transmitting an elevator call for the first robot to use the first elevator system when the number of individuals with the elevator lobby is less than a selected number of individuals.

In addition to one or more of the features described herein, or as an alternative, further embodiments may include: detecting a number of individuals within an elevator lobby of the first elevator system using the sensor system of the first robot; and delaying transmission of an elevator call for the first robot to use the first elevator system when the number of individuals with the elevator lobby is greater than a selected number of individuals.

According to another embodiment, a computer program product embodied on a non-transitory computer readable medium is provided the computer program product including instructions that, when executed by a processor, cause the processor to perform operations including: detecting an individual using a sensor system of a first robot; and notifying a dispatcher of the first elevator system that the individual was detected.

According to another embodiment, a method of operating a first elevator system comprising a first elevator car is provided. The method including: transporting an elevator call device using a first robot, the elevator call device being configured to transmit elevator calls for the first elevator system.

In addition to one or more of the features described herein, or as an alternative, further embodiments may include: detecting traffic conditions of the first elevator system, wherein the first robot is configured to transport the elevator call device in response to the traffic conditions of the elevator system.

In addition to one or more of the features described herein, or as an alternative, further embodiments may include: that the robot is configured to transport the elevator call device away from the first elevator system when the traffic conditions indicate increase use of the first elevator system or towards the elevator system when the traffic conditions indicate decreased use of the first elevator system.

In addition to one or more of the features described herein, or as an alternative, further embodiments may include: detecting a number of individuals in an elevator lobby of the first elevator system, wherein the first robot is configured to transport the elevator call device in response to the number of individuals in the elevator lobby.

In addition to one or more of the features described herein, or as an alternative, further embodiments may include that the robot is configured to move the elevator call device away from the first elevator system when the number of individuals is greater than a selected number of individuals.

In addition to one or more of the features described herein, or as an alternative, further embodiments may include: communicating with individuals using at least one of the robot and the elevator call device.

Technical effects of embodiments of the present disclosure include using a robot to detect individuals.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a robot coordination system, in accordance with an embodiment of the disclosure; and

FIG. 3 is a flow chart of method of controlling a first elevator system comprising a first elevator car using a robot coordination system of FIG. 2, in accordance with an embodiment of the disclosure.

### DETAILED DESCRIPTION

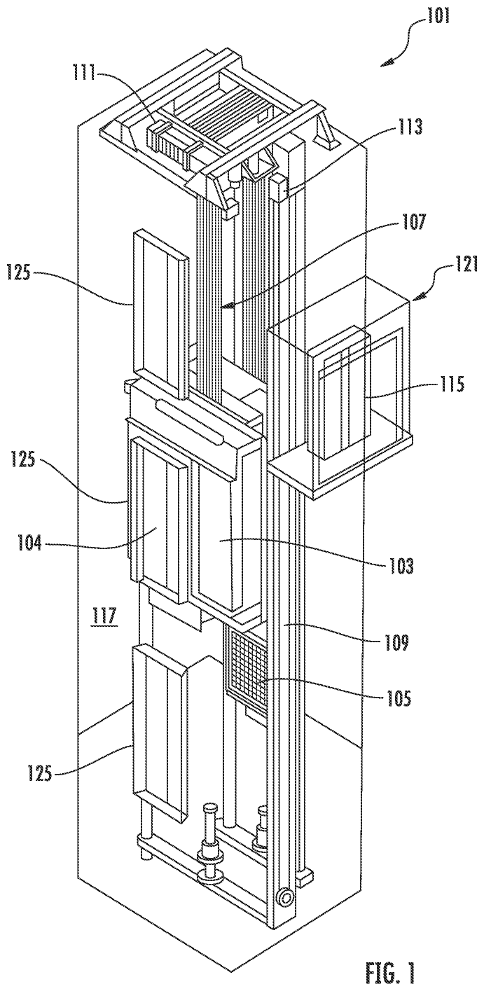

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable conveyance systems such as an elevator system 101 and a conveyance apparatus of the conveyance system such as an elevator car 103 of the elevator system 101. In another example, embodiments disclosed herein may be applicable conveyance systems such as an escalator system and a conveyance apparatus of the conveyance system such as a moving stair of the escalator system.

The elevator system 101 also includes one or more elevator doors 104. The elevator door 104 may be integrally attached to the elevator car 103 and/or the elevator door 104 may be located on a landing 125 of the elevator system 101. Embodiments disclosed herein may be applicable to both an elevator door 104 integrally attached to the elevator car 103 and/or an elevator door 104 located on a landing 125 of the elevator system 101. The elevator door 104 opens to allow passengers to enter and exit the elevator car 103.

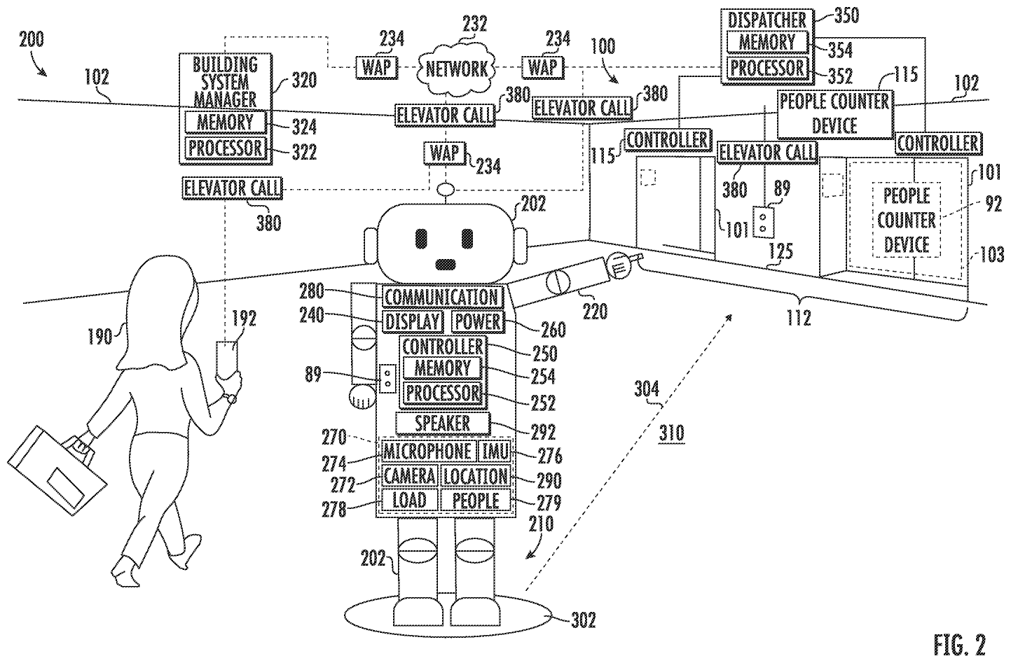

Referring now to FIG. 2, with continued reference to FIG. 1, a robot coordination system 200 is illustrated, in accordance with an embodiment of the present disclosure. It should be appreciated that, although particular systems are separately defined in the schematic block diagrams, each or any of the systems may be otherwise combined or separated via hardware and/or software. The robot coordination system 200 comprises and/or is in wireless communication with a robot 202. It is understood that while one robot 202 is illustrated, the embodiments disclosed herein may be applicable to a robot coordination system 200 having one or more robots 202. The robot 202 may desire to utilize an elevator system 101 and the robot coordination system 200 may coordinate use of the elevator system 101 by the robot 202 and individuals 190.

It is understood that while elevator systems 101 are utilized for exemplary illustration, embodiments disclosed herein may be applied to other conveyance systems utilizing conveyance apparatuses for transportation such as, for example, escalators, moving walkways, etc.

As illustrated in FIG. 2, a building elevator system 100 within a building 102 may include multiple different individual elevator systems 101 organized in an elevator bank 112. The elevator systems 101 each include an elevator car 103 (one elevator car 103 is not shown in FIG. 2 for simplicity). It is understood that while two elevator systems 101 are utilized for exemplary illustration, embodiments disclosed herein may be applied to building elevator systems 100 having one or more elevator systems 101. Further, the elevator systems 101 illustrated in FIG. 2 are organized into an elevator bank 112 for ease of explanation but it is understood that the elevator systems 101 may be organized into one or more elevator banks 112. Each of the elevator banks 112 may contain one or more elevator systems 101. Each of the elevator banks 112 may also be located on different landings 125.

Additionally there may be an elevator call device 89 located proximate the elevator systems 101 on the landing 125 and/or an elevator call device 89 of the robot 202 that may move with the robot 202. The elevator call device 89 may be attached to the robot 202 or the robot 202 may be holding the elevator call device 89. The elevator call device 89 transmits an elevator call 380 to a dispatcher 350 of the building elevator system 100. It should be appreciated that, although the dispatcher is separately defined in the schematic block diagrams, the dispatcher 350 may be combined via hardware and/or software in any controller 115 or other device. The elevator call 380 may include the source of the elevator call 380. The elevator call device 89 may include a destination entry option that includes the destination of the elevator call 380. The elevator call device 89 may be a push button and/or a touch screen and may be activated manually or automatically. For example, the elevator call 380 may be sent by an individual 190 or a robot 202 entering the elevator call 380 via the elevator call device 89. As illustrated in FIG. 2, the robot 202 may utilize a communication module 280 to communicate either directly to the building elevator system 100 and indirectly with the building elevator system 100 through a computing network 232.

The elevator call device 89 located on the robot 202 may be incorporated into or associated with the display device 240 of the robot 202. For example, the display device 240 may be a touchscreen, thus allowing an individual 190 enter an elevator call 230 by touching the touchscreen of the display device 240. The robot 202 and associated elevator call device 89 may be moved based on traffic conditions including traffic volume and traffic direction (e.g., morning entry vs. evening exit, etc.). The robot 202 may transport the elevator call device 89 response to detected traffic conditions in the elevator system 101. The robot 202 may transport the elevator call device 89 away from the first elevator system 101 when the traffic conditions indicate increased use of the first elevator system 101 or towards the elevator system 101 when the traffic conditions indicate decreased use of the first elevator system 101. A number of individuals 190 may be detected in an elevator lobby 310 of the first elevator system 101 (e.g., using the robot 202 and/or people counter device 92) and then the robot 202 is configured to transport the elevator call device 89 in response to the number of individuals 190 in the elevator lobby 310. For example, the robot 202 is configured to move the elevator call device 89 away from the first elevator system 101 when the number of individuals 190 is greater than a selected number of individuals (e.g., a large crowd has formed). For example, the robot 202 is configured to move the elevator call device 89 towards the first elevator system 101 when the number of individuals 190 is less than a selected number of individuals (e.g., there is no crowd or the crowd has dissipated).

In some embodiments, the elevator call device 89 and/or robot 202 may communicate with individuals 190. The purpose of the communication may be to give calling instructions. For example, instruct on where to stand and give other elevator etiquette/instructions (e.g., do not block doors for exiting passengers, do not enter multiple calls, etc.)

A mobile device 192 may also be configured to transmit an elevator call 380. The robot 202 or the individual 190 may be in possession of the mobile device 192 to transmit the elevator call 380. The mobile device 192 may be a smart phone, smart watch, laptop, or any other mobile device known to one of skill in the art. The mobile device 192 may be configured to transmit the elevator call 380 through computing network 232 to the dispatcher 350. The mobile device 192 may communicate to the computer network 232 through a wireless access protocol device (WAP) 234 using short-range wireless protocols. Short-range wireless protocol may include, but are not limited to, Bluetooth, Wi-Fi, HaLow (801.11ah), zWave, ZigBee, or Wireless M-Bus. Alternatively, the mobile device 192 may communicate directly with the computer network 232 using long-range wireless protocols. Long-range wireless protocols may include, but are not limited to, cellular, LTE (NB-IoT, CAT M1), LoRa, satellite, Ingenu, or SigFox.

The controllers 115 can be combined, local, remote, cloud, etc. The dispatcher 350 may be local, remote, cloud, etc. The dispatcher 350 is in communication with the controller 115 of each elevator system 101. Alternatively, there may be a single controller that is common to all of the elevator systems 101 and controls all of the elevator system 101, rather than two separate controllers 115, as illustrated in FIG. 2. The dispatcher 350 may be a ‘group’ software that is configured to select the best elevator car 103 to be assigned to the elevator call 380. The dispatcher 350 manages the elevator call devices 89 related to the elevator bank 112.

The dispatcher 350 is configured to control and coordinate operation of multiple elevator systems 101. The dispatcher 350 may be an electronic controller including a processor 352 and an associated memory 354 comprising computer-executable instructions that, when executed by the processor 352, cause the processor 352 to perform various operations. The processor 352 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 354 may be but is not limited to a random access memory (RAM), read only memory (ROM), or other electronic, optical, magnetic or any other computer readable medium.

The dispatcher 350 is in communication with the elevator call devices 89 of the building elevator system 100 and the robot 202. The dispatcher 350 is configured to receive the elevator call 380 transmitted from the elevator call device 89, the mobile device 192, and/or the robot 202. The dispatcher 350 is configured to manage the elevators calls 380 coming in from the elevator call device 89, mobile devices 192, and/or the robot 202 then command one or more elevator systems 101 to respond to elevator call 380.

The robot 202 may be configured to operate fully autonomously using a controller 250 to control operation of the robot 202. The controller 250 may be an electronic controller that includes a processor 252 and an associated memory 254 including computer-executable instructions that, when executed by the processor 252, cause the processor 252 to perform various operations. The processor 252 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 254 may be a storage device such as, for example, a random access memory (RAM), read only memory (ROM), or other electronic, optical, magnetic or any other computer readable medium.

The robot 202 includes a power source 260 configured to power the robot 202. The power source 260 may include an energy harvesting device and/or an energy storage device. In an embodiment, the energy storage device may be an onboard battery system. The battery system may include but is not limited to a lithium ion battery system. The robot 202 may be configured to move to an external power source (e.g., electrical outlet) to recharge the power source 260.

The robot 202 includes a speaker 292 configured to communicate audible words, music, and/or sounds to individuals 190 located proximate the robot 202. The robot 202 also includes a display device 240 configured to display information visually to individuals 190 located proximate the robot 202. For example, the display device 240 may be a flat screen monitor, a computer tablet, or smart phone device. In an embodiment, the display device 240 may be located on the head of the robot 202 or may replace the head of the robot 202. In an embodiment, the display device 240 a computer tablet or similar display device that is carried by the robot 202.

The robot 202 may be stationed (i.e., located) permanently or temporarily within an elevator lobby 310 that is located on the landing 125 proximate the elevator system 101. The robot 202 may include a propulsion system 210 to move the robot 202. The robot 202 may move throughout the elevator lobby 310, move away from the elevator lobby 310 throughout the landing 125, and/or may move to other landings via the elevator system 101 and/or a stair case (not shown). The propulsion system 210 may be a leg system, as illustrated in FIG. 2, that simulates human legs. As illustrated in FIG. 2, the propulsion system 210 may include two or more legs 212, which are used to move the robot 202. It is understood that while the leg system is utilized for exemplary illustration, embodiments disclosed herein may be applicable to robots having other propulsion systems for transportation such as, for example, a wheel system, a rotorcraft system, a hovercraft system, a tread system, or any propulsion system may be known of skill in the art may be utilized. It is also understood that a robot 202 having a humanoid appearance is utilized for exemplary illustration, embodiments disclosed herein may be applied to robots that do not have a humanoid appearance.

The robot 202 includes a sensor system 270 to collect sensor data. The sensor system 270 may include, but is not limited, to an inertial measurement unit (IMU) sensor 276, a camera 272, a microphone 274, a location sensor system 290, a load detection system 278, and a people counter system 279. The IMU sensor 276 is configured to detect accelerations of the robot 202. The IMU sensor 276 may be a sensor such as, for example, an accelerometer, a gyroscope, or a similar sensor known to one of skill in the art. The IMU sensor 276 may detect accelerations as well as derivatives or integrals of accelerations, such as, for example, velocity, jerk, jounce, snap . . . etc.

The camera 272 may be configured to capture images of areas surrounding the robot 202. The camera 272 may be a still image camera, a video camera,depth sensor, thermal camera, and/or any other type of imaging device known to one of skill in the art. In one embodiment, the controller 250 may be configured to analyze the images captured by the camera 272 using image recognition to identify an individual 190. In another embodiment, the controller 250 may be configured to transmit the images as raw data for processing by the building system manager 320. The image recognition may identify the individual 190 using facial recognition. The robot 202 may utilize image recognition to identify and an individual 190 that is boarding an elevator car 103 and then check whether the individual 190 has transmitted an elevator call 380 to the dispatcher 350 or is “piggy-backing” on an elevator call 380 of another individual 190. The robot 202 may communicate with the dispatcher 350 in real-time to look out for piggy-backing. Additionally, the robot 202 may ride the elevator car 103 to monitor for piggy-backing.

The microphone 274 is configured to detect sound. The microphone 274 is configured to detect audible sound proximate the robot 202, such as, for example, language spoken an individual 190 proximate the robot 202. In one embodiment, the controller 250 may be configured to analyze the sound captured by the microphone 274 using language recognition software and respond accordingly. In another embodiment, the controller 250 may be configured to transmit the sound as raw data for processing by the building system manager 320. The sound (i.e., voice) from an individual 190 may be analyzed to identify the individual 190 using voice recognition.

In one embodiment, the controller 250 may be configured to analyze the sound captured by the microphone 274 using voice recognition to identify an individual 190. In another embodiment, the controller 250 may be configured to transmit the sound as raw data for processing by the building system manager 320.

The dispatcher 350 may coordinate one or more robots 202 to all ride together in a single elevator car 103 to avoid interaction with individuals 190 (e.g., all robot cars). The dispatcher 350 may cancel elevator calls 380 received from robots 202 and/or instruct the robot 202 to wait if the traffic from individuals 190 is high at a given time. The dispatcher 350 may also instruct the robot 202 to take the stairs or an escalator. The dispatcher 350 may instruct the robot 202 to move to another elevator bank if one particular elevator bank is busy.

The robot 202 may utilize a load carrying mechanism 220 to delivery items. In FIG. 2, the load carrying mechanism 220 are arms of the robot 202. It is understood that the arms of the robot 202 are an example and the robot 202 may utilize other load carrying mechanism, such as, for example, a pallet, a crane, a flat bed, secure compartment, or other load carrying mechanism known to one of skill in the art. Additionally, the robot 202 may be utilized to pull or tow an item, such as, for example, a hospital bed or a wheel chair. In other embodiment, the robot 202 may be an autonomous hospital bed or an autonomous wheel chair.

The load detection system 278 may be configured to detect a weight of the load being carried or pushed by the load carrying mechanism 220. A robot 202 may be directed to certain elevator cars 103 based on the weight detected by the load detection system 278. For example, a robot 202 carrying an excessively heavy load may be directed to ride a freight elevator that is configured to handle excess load. Additionally, if the load being carried by two robots 202 exceeds the weight limits of an elevator car 103, the robots 202 may be instructed to ride separately.

Each elevator call 380 transmitted by a robot 202 may include a call code that may indicate the type of elevator call 380 including the item being transported by the robot 202 and/or the urgency of the elevator call 380. In one example, the call code may indicate that the robot 202 is transporting laundry, which may not be considered urgent. In another example, the call code may indicate that the robot 202 is transporting transplant organs, which may be considered urgent. When the dispatcher 350 receives the elevator call 380 the dispatcher 350 will analyze the code and determine its urgency in comparison to other elevator calls 380 received. Elevator calls 380 that are most urgent will be assigned first, while those that are not urgent may be relegated to wait. Call codes may also be included and/or applied to elevator calls 380 received from individuals 190. In one example, each elevator call 380 transmitted may receive the same call code, meaning that the every elevator call 380 from an individual 190 would be treated with the same priority and a robot 202 that has an urgent call code may take higher priority than the call code of the individuals 190, whereas a robot 202 with a non-urgent call code may take a lower priority than the call code of the individuals 190. In another example, different individuals 190 may be assigned a different call codes based on either a VIP status or based on job roles. Further, an emergency room physicians may have a call code that gives them the highest priorities over other call codes.

The robot 202 also includes a location sensor system 290 configured to detect a location 302 of the robot 202. The location 302 of the robot 202 may also include the location 302 of the robot 202 relative to other objects in order allow the robot 202 to navigate through hallways of a building 102 and prevent the robot 202 from bumping into objects or individuals 190. The location sensing system 290 may use one or a combination or sensing devices including but not limited to GPS, wireless signal triangulation, SONAR, RADAR, LIDAR, image recognition, or any other location detection or collision avoidance system known to one of skill in the art. The location sensor system 290 may utilize GPS in order to detect a location 302 of the robot 202. The location sensor system 290 may utilize triangulation of wireless signals within the building 102 in order to determine a location 302 of the robot 202 within a building 102. For example, the location sensor system 290 may triangulate the position of the robot 202 within a building 102 utilizing received signal strength (e.g., RSSI) of wireless signals from WAPs 234 in known locations throughout the building 102. In order to avoid colliding with objects, the location sensor system 290 may additionally use SONAR, RADAR, LIDAR, or image recognition (Convolutional Neural Networks). Upon initial deployment or a location reset, the robot 202 may perform a learn mode, such that the robot 202 may become familiar with the environment.

The location 302 of the robot 202 may also be communicated to the dispatcher 350 when the robot 202 desires to use the elevator system 101. By knowing the location 302 of the robot 202, the distance away from the elevator bank 112 (e.g., elevator system 101) along a probable path 304, and the movement speed of the robot 202, then the dispatcher 350 may call an elevator car 103 to arrive at the elevator bank 112 at or before when the robot 202 arrives at the elevator bank 112. Use of the elevator systems 101 may be limited to learnt periods of low traffic of individuals 190. The traffic patterns of individuals 190 may be learnt using the people counter system 279 or a people counter device 92.

The robot 202 includes a communication module 280 configured to allow the controller 250 of the robot 202 to communicate with the building system manager 320 and the dispatcher 350. The communication module 280 is capable of transmitting and receiving data to and from the dispatcher 350 through a computer network 232. The computer network 232 may be a cloud computing network. The communication module 280 is capable of transmitting and receiving data to and from the building system manager 320 through the computer network 232. In another embodiment, the communication module 280 is capable of transmitting and receiving data to and from the dispatcher 350 by communicating directly with the dispatcher 350.

The communication module 280 may communicate to the computer network 232 through a wireless access protocol device (WAP) 234 using short-range wireless protocols. Alternatively, the communication module 280 may communicate directly with the computer network 232 using long-range wireless protocols.

The communication module 280 may communicate to the dispatcher 350 through a WAP 234 using short-range wireless protocols. Alternatively, the communication module 280 may communicate directly with the dispatcher 350 using short-range wireless protocols.

The building system manager 320 may communicate to the computer network 232 through a WAP 234 using short-range wireless protocols. The building system manager 320 may communicate directly with the computer network 232 using long-range wireless protocols.

The building system manager 320 is an electronic controller that includes a processor 322 and an associated memory 324 including computer-executable instructions that, when executed by the processor 322, cause the processor 322 to perform various operations. The processor 322 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 324 may be a storage device such as, for example, a random access memory (RAM), read only memory (ROM), or other electronic, optical, magnetic or any other computer readable medium.

The building system manager 320 may be configured to obtain, store, and provide to the robot 202 information that may be useful to the robot 202. The information may include a directory of the building 102 including images of individuals 190 that may be used for facial recognition or voice signatures of individuals 190 that may be used for voice recognition of individuals 190 to call an elevator cars 103 for the individuals 190, as described above. The information may also include directory information of people or locations within the building 102 and/or in the area surrounding the building 102. The building system manager 320 may also perform climate control within the building 102 and/or building access control for the building 102.

The people counter system 279 is configured to detect or determine a people count. The people count may be a number of individuals 190 located within an elevator car 103, a number of individuals 190 boarding or exiting an elevator car 103, a number of individuals 190 located on a landing 125, or a number of individuals 190 located in an elevator lobby 310 on a landing 125. The people count may be an exact number of individuals 190 or an approximate number of individuals 190.

The people counter system 279 may utilize the camera 272 for people counting. The people counter system 279 may be used to determine a number of individuals 190 proximate the elevator systems 101, a number of individuals 190 within an elevator lobby 310 proximate the elevator systems 101, a number of individuals 190 on their way to the elevator system 101, a number of individuals 190 boarding an elevator car 103, a number of individuals 190 exiting an elevator car 103, and/or a number of individuals 190 within the elevator car 103. Individuals 190 being located proximate the elevator system 101 and/or within the elevator lobby 310 is indicative that the individuals 190 would like to board an elevator car 103 of the elevator system 101.

The people counter system 279 may utilize one or more detection mechanisms of the robot 202, such as, for example the camera 272, a depth sensing device, a radar device, a laser detection device, a mobile device (e.g., cell phone) tracker using the communication device 280, and/or any other desired device capable of sensing the presence of individuals 190. The people counter system 279 may utilize the camera 272 for visual recognition to identify individual individuals 190 and objects. A fullness percentage of an elevator car 103 may be determined from detection of individuals 190 and/or objects within the elevator car 103. The laser detection device may detect how many passengers walk through a laser beam to determine the number of individuals 190. The thermal detection device may be an infrared or other heat sensing camera that utilizes detected temperature to identify individual individuals 190 and objects and then determine the number of individuals 190. The depth detection device may be a 2-D, 3-D or other depth/distance detecting camera that utilizes detected distance to an object and/or individuals 190 to determine the number of individuals 190. The communication device 280 may act as a mobile device tracker may determine a number of individuals 190 on a landing 125, in an elevator lobby 310, or in an elevator car 103 by detecting mobile device wireless signals and/or detecting how many mobile devices 192 are utilizing a specific application on the mobile device 192 on a landing 125, in an elevator lobby 310, or in an elevator car 103. As may be appreciated by one of skill in the art, in addition to the stated methods, additional methods may exist to sense the number of individuals 190 and one or any combination of these methods may be used to determine the number of individuals 190 on a landing 125, in an elevator lobby 310, in an elevator car 103, or on their way to the elevator system 101.

In one embodiment, the people counter system 279 is able to detect the people count through image pixel counting. For example, the people count may compare a current image of the elevator lobby 310 to a stock image of the elevator lobby 310. For example, the people counter system 279 may utilize pixel counting by capturing a current image of the elevator lobby 310 and comparing the current image of the elevator lobby 310 to a stock image of the elevator lobby 310 that illustrates the elevator lobby 310 with zero individuals 190 present or a known number of individuals 190 present. The number of pixels that are different between the stock image and the current image may correlate with the people count within the elevator lobby 310. It is understood that the embodiments disclosed herein are not limited to pixel counting to determine a people count and thus a people count may be determined utilizing other methods including but not limited to video analytics software. Video analytics may identify individuals 190 from stationary objections and count each person separately to determine a total number of individuals 190.

The people count may be determined using a machine learning, deep learning, and/or artificial intelligence module. The artificial intelligence module can be located within the robot 202, the building system manager 320, or the dispatcher 350. The people count may alternatively be expressed as a percentage from zero-to-one-hundred percent indicating what percentage of pixels are different between the stock image and the current image. The people count may be expressed as a scale of one-to-ten (e.g., one being empty and ten being full) indicating what percentage of pixels are different between the stock image and the current image. The people count may be expressed as an actual or estimated number of individuals 190, which may be determined in response to the number of pixels that are different between the stock image and the current image.

The landing 125 in the building 102 of FIG. 2 or the elevator car 103 may also include a people counter device 92 that works in collaboration with the people counter system 279 of the robot 202 to determine the people count. The people counter device 92 may be located within the elevator car 103 to capture a number of individuals 190 within the elevator car 103. The people counter device 92 may be located within elevator lobby 310 to capture a number of individuals 190 within the elevator lobby 310. It is understood that there may be more than one people counter device 92 utilized in the building elevator system 100. The people counter device 92 may be in real-time communication with the people counter system 279 of the robot 202 to accurately determine a people count.

The people counter device 92 may include one or more detection mechanisms, such as, for example a weight sensing device, a visual recognition device, depth sensing device, radar device, a laser detection device, mobile device (e.g., cell phone) tracking, and/or any other desired device capable of sensing the presence of individuals 190. The visual recognition device may be a camera that utilizes visual recognition to identify individual individuals 190 and objects in elevator lobby 310 or elevator car 103. A fullness percentage of an elevator car 103 may be determined from detection of individuals 190 and/or objects within the elevator car 103. The weight detection device may be a scale to sense the amount of weight in an elevator lobby 310 or elevator car 103 then determine the number of individuals 190. The laser detection device may detect how many passengers walk through a laser beam to determine the number of individuals 190 in the elevator lobby 310 or elevator car 103. The thermal detection device may be an infrared or other heat sensing camera that utilizes detected temperature to identify individual individuals 190 and objects in the elevator lobby 310 or elevator car 103 then determine the number of individuals 190. The depth detection device may be a 2-D, 3-D or other depth/distance detecting camera that utilizes detected distance to an object and/or individuals 190 to determine the number of individuals 190. The mobile device tracking may determine a number of individuals 190 on a landing 125, in elevator lobby 310, or elevator car 103 by detecting mobile device wireless signals and/or detecting how many mobile devices 192 are utilizing a specific application on the mobile device 192 on the landing 125, in the elevator lobby 310, or in the elevator car 103. As may be appreciated by one of skill in the art, in addition to the stated methods, additional methods may exist to sense the number of individuals 190 and one or any combination of these methods may be used to determine the number of individuals 190 on a landing 125, in elevator lobby 310, or elevator car 103.

In one embodiment, the people counter device 92 is able to detect the people count through image pixel counting. For example, the people count may compare a current image of the elevator lobby 310 to a stock image of the elevator lobby 310. For example, the people counter device 92 may utilize pixel counting by capturing a current image of the elevator lobby 310 and comparing the current image of the elevator lobby 310 to a stock image of the elevator lobby 310 that illustrates the elevator lobby 310 with zero individuals 190 present or a known number of individuals 190 present. The number of pixels that are different between the stock image and the current image may correlate with the people count within the elevator lobby 310. It is understood that the embodiments disclosed herein are not limited to pixel counting to determine a people count and thus a people count may be determined utilizing other methods including but not limited to video analytics software. Video analytics may identify individuals 190 from stationary objections and count each person separately to determine a total number of individuals 190.

The people count may be determined using a machine learning, deep learning, and/or artificial intelligence module. The artificial intelligence module can be located in the people counter device 92 or in a separate module in the dispatcher 350. The separate module may be able to communicate with the people counter device 92. The people count may alternatively be expressed as a percentage from zero-to-one-hundred percent indicating what percentage of pixels are different between the stock image and the current image. The people count may be expressed as a scale of one-to-ten (e.g., one being empty and ten being full) indicating what percentage of pixels are different between the stock image and the current image. The people count may be expressed as an actual or estimated number of individuals 190, which may be determined in response to the number of pixels that are different between the stock image and the current image.

The people count determined by at least one of people counter system 279 of the robot 202 and the people counter device 92 may be transmitted to the dispatcher 350 to adjust operation of the elevator systems 101. For example, if the people count is high meaning that there are a large number of individuals 190 then the dispatcher 350 will send more elevator cars 103 to the elevator lobby 310.

Advantageously, the robot 202 is able to move away from the elevator lobby 310 and thus may be able to detect crowds of individuals 190 in advance of the crowd of individuals 190 reaching the elevator lobby 310. The crowd of individuals 190 the dispatcher 350 may then be reported to the dispatcher 350 and the dispatcher 350 may call elevators cars 103 in advance of the crowd of individuals 190 reaching the elevator lobby 310, which advantageously saves time by helping to clear out the crowd of individuals 190 from the elevator lobby 310 faster. Also advantageously, in the event that the elevator car 103 does not include a people counter device 92, then the robot 202 may ride the elevator car 103 and communicate the people count back to the dispatcher 350.

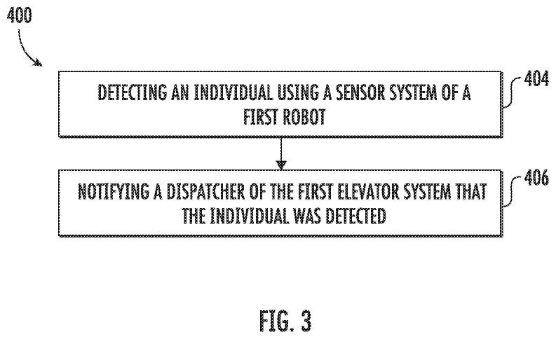

Referring now to FIG. 3, with continued reference to FIGS. 1-2, a flow chart of method 400 of operating a first elevator system 101 comprising a first elevator car 103 is illustrated, in accordance with an embodiment of the disclosure. In an embodiment, the method 400 is performed by the robot coordination system 200 of FIG. 2.

At block 404, an individual 190 is detected using a sensor system 270 of a first robot 202. At block 406, a dispatcher 350 of the first elevator system 101 is notified that the individual 190 was detected.

In an embodiment, the sensor system 270 of the first robot 202 detects the individual 190 approaching the first elevator system 101 and it is then determined that the individual 190 would like to utilize the first elevator system 101. Once it is determined that the individual 190 would like to utilize the first elevator system 101 an elevator call 380 is transmitted to the first elevator system 101.

In an embodiment, the sensor system 270 of the first robot 202 detects the individual 190 entering the first elevator car 103 and notifies a dispatcher 350 of the first elevator system 101 that the individual 190 has entered the first elevator car 103. It may be determined that the individual 190 did not request the first elevator car 103 through an elevator call 380, or in other words the individual 190 is “piggy-backing” on an elevator call 380 submitted by another individual 190. Alternatively, it may be determined that the individual 190 did request the first elevator car 103 through an elevator call 380. Advantageously, this detection ability gives the dispatcher 350 to understand how many individuals 190 are actually utilizing the elevator car 103 in real-time and adjust the operation of the elevator system 101 accordingly.

In an embodiment, the sensor system 270 of the first robot 202 detects the individual 190 exiting the first elevator car 103 and notifying a dispatcher 350 of the first elevator system 101 that the individual 190 has exited the elevator car 103. For example, the robot 202 may have entered into the elevator car 103 with the individual 190 and is tracking the movement of the individual 190 to better help guide the dispatcher 350 in operation of the elevator car 103.

In an embodiment, the sensor system 270 of the first robot 202 detects the individual 190 within the first elevator car 103 and notifies a dispatcher 350 of the first elevator system 101 that the individual 190 is within the elevator car 103.

In an embodiment, the sensor system 270 of the first robot 202 detects a number of individuals 190 within the first elevator car 103 and notifies a dispatcher 350 of the first elevator system 101 of the number of individuals 190 within the elevator car 103.

In an embodiment, the sensor system 270 of the first robot 202 detects a fullness percentage of the first elevator car 103 and notifies a dispatcher 350 of the fullness percentage. Advantageously, the fullness percentage may help the dispatcher 350 determine whether to make any more stops to pick up additional individuals.

In another embodiment, an elevator call 380 is received from the individual 190 via an elevator call device 89 of the first robot 202 and the elevator call 380 is transmitted from the robot 202 to a dispatcher 350 of the first elevator system 101. Advantageously, by locating the elevator call device 89 with the robot 202, the elevator call device 89 is free to move around the elevator lobby 310 with the robot 202 and thus allows individuals 190 to make elevator calls 380 anywhere in the elevator lobby 310. This may be especially helpful when there is a large crowd by the elevator call device 89 attached to a wall proximate the elevator bank 112 and an individual 190 may not be able to get to the elevator call device 89 attached to the wall proximate the elevator bank 112. The dispatcher 350 may determine that the first elevator car 103 can accommodate the first elevator call 380 and instruct the first elevator car 103 to move to a landing 125 where the individual 190 is located. Once at the landing where the individual 190 is located it may be determined when the individual 190 has entered the first elevator car 103 using the sensor system 270 of the robot 202 and then the first robot 202 may be instructed to enter the first elevator car 103 after the individual 190 has entered the first elevator car 103. The robot 202 may also wait to enter the first elevator car 103 until it has been determined that no other individuals 190 are entering the first elevator car 103 using the sensor system 270 of the robot 202.

The first elevator car 103 may be moved to a destination of the elevator call 380 when the individual 190 has entered the first elevator car 103. It may be determined when the individual 190 has exited the first elevator car 103 at the landing 125 using the sensor system 270 of the robot 202 and the first robot 202 is instructed to exit the first elevator car 103 after the individual 190 has exited the first elevator car 103. The robot 202 may also wait to exit the first elevator car 103 until it has been determined that no other individuals 190 are exiting the first elevator car 103 using the sensor system 270 of the robot 202.

The method 400 may further comprise that a number of individuals 190 within an elevator lobby of the first elevator system 101 is detected using a sensor system 270 of the first robot 202 and an elevator call 380 for the first robot 202 to use the first elevator system 101 is transmitted when the number of individuals 190 with the elevator lobby 310 is less than a selected number of individuals 190. Alternatively, a number of individuals 190 within an elevator lobby 310 of the first elevator system 101 is detected using a sensor system 270 of the first robot 202 and transmission of an elevator call 380 for the first robot 202 to use the first elevator system 101 is delayed when the number of individuals 190 with the elevator lobby 310 is greater than a selected number of individuals 190. Thus, the robot 202 may be forced to wait to use the first elevator system 101 if there are too many individuals 190 in the elevator lobby waiting to use the first elevator system 101.

While the above description has described the flow process of FIG. 3 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of operating a first elevator system comprising a first elevator car, the method comprising:
detecting an individual using a sensor system of a first robot; and
notifying a dispatcher of the first elevator system that the individual was detected.

2. The method of claim 1, further comprising:
detecting the individual approaching the first elevator system using the sensor system of the first robot;
determining that the individual would like to utilize the first elevator system; and
transmitting an elevator call to the first elevator system.

3. The method of claim 1, further comprising:
detecting the individual entering the first elevator car using the sensor system of the first robot; and
notifying the dispatcher of the first elevator system that the individual has entered the first elevator car.

4. The method of claim 3, further comprising:
determining that the individual did not request the first elevator car through an elevator call.

5. The method of claim 3, further comprising:
determining that the individual did request the first elevator car through an elevator call.

6. The method of claim 1, further comprising:
detecting the individual exiting the first elevator car using the sensor system of the first robot; and
notifying the dispatcher of the first elevator system that the individual has exited the elevator car.

7. The method of claim 1, further comprising:
detecting the individual within the first elevator car using the sensor system of the first robot; and
notifying the dispatcher of the first elevator system that the individual is within the elevator car.

8. The method of claim 1, further comprising:
detecting a number of individuals within the first elevator car using the sensor system of the first robot; and
notifying the dispatcher of the first elevator system of the number of individuals within the elevator car.

9. The method of claim 7, further comprising:
detecting a fullness percentage of the first elevator car using the sensor system of the first robot; and
notifying the dispatcher of the fullness percentage.

10. The method of claim 1, further comprising:
receiving an elevator call from the individual via an elevator call device of the first robot; and
transmitting the elevator call from the robot to a dispatcher of the first elevator system.

11. The method of claim 10, further comprising:
determining that the first elevator car can accommodate the first elevator call; and
instructing the first elevator car to move to a landing where the individual is located.

12. The method of claim 11, further comprising:
determining when the individual has entered the first elevator car using the sensor system of the first robot; and
instructing the first robot to enter the first elevator car after the individual has entered the first elevator car.

13. The method of claim 11, further comprising:
determining when the individual has entered the first elevator car using the sensor system of the first robot;
determining that no other individuals are entering the first elevator car using the sensor system of the first robot; and
instructing the first robot to enter the first elevator car after the individual has entered the first elevator car and it has been determined that no other individuals are entering the first elevator car.

14. The method of claim 11, further comprising:
moving the first elevator car to a destination of the elevator call when the individual has entered the first elevator car.

15. The method of claim 14, further comprising:
determining when the individual has exited the first elevator car at the landing using the sensor system of the first robot; and
instructing the first robot to exit the first elevator car after the individual has exited the first elevator car.

16. The method of claim 14, further comprising:
determining when the individual has exited the first elevator car at the landing using the sensor system of the first robot;
determining that no other individuals are exiting the first elevator car using the sensor system of the first robot; and
instructing the first robot to exit the first elevator car after the individual has exited the first elevator car and it has been determined that no other individuals are exiting the first elevator car.

17. The method of claim 1, further comprising:
detecting a number of individuals within an elevator lobby of the first elevator system using the sensor system of the first robot; and
transmitting an elevator call for the first robot to use the first elevator system when the number of individuals with the elevator lobby is less than a selected number of individuals.

18. The method of claim 1, further comprising:
detecting a number of individuals within an elevator lobby of the first elevator system using the sensor system of the first robot; and
delaying transmission of an elevator call for the first robot to use the first elevator system when the number of individuals with the elevator lobby is greater than a selected number of individuals.

19. A computer program product embodied on a non-transitory computer readable medium, the computer program product including instructions that, when executed by a processor, cause the processor to perform operations comprising:
detecting an individual using a sensor system of a first robot; and
notifying a dispatcher of the first elevator system that the individual was detected.

20. A method of operating a first elevator system comprising a first elevator car, the method comprising:
transporting an elevator call device using a first robot, the elevator call device being configured to transmit elevator calls for the first elevator system.
